(19) United States
(12) Patent Application Publication
(10) Pub. No.: US 2010/0138499 A1
(43) Pub. Date: Jun. 3, 2010

(54) Method and Apparatus for Aggregating E-Mail Reply Data

(75) Inventors: Steven Belz, Cedar Park, TX (US); James Pratt, Round Rock, TX (US); Marc Sullivan, Austin, TX (US)

Correspondence Address: AT & T Legal Department - WS;Attn: Patent Docketing, Room 2A-207, One AT & T Way, Bedminster, NJ, 07921, US

(73) Assignee: AT&T INTELLECTUAL PROPERTY I, L.P., Reno, NV (US)

(21) Appl. No.: 12/327,129

(22) Filed: Dec. 3, 2008

(51) Int. Cl. G06F 15/16

(52) U.S. Cl. 709/206

(57) ABSTRACT

A method is disclosed comprising sending an original e-mail message to a plurality of recipients, and receiving a plurality of received e-mails. For each of the plurality of received e-mails, the method includes determining if each received e-mail is a reply to the original e-mail message, and extracting data from each received e-mail that is a reply to the original e-mail message. The extracted data is aggregated to form aggregated data, and information relating to the aggregated data is displayed. The information may be displayed on a computer monitor along with the original e-mail message.

### BACKGROUND OF THE INVENTION

This invention relates generally to e-mail (electronic mail) and more specifically to replies to e-mail messages.

An original e-mail message very often is sent out to a plurality of recipients for example on a distribution list. Each recipient may respond with a reply e-mail message, which typically results in a plurality of reply e-mail messages being sent to the sender of the original e-mail message. The sender then needs to review each of the plurality of reply e-mail messages to determine the content of these messages. This can be very time consuming, particularly if a large number of recipients replied to the original e-mail message. In addition, the sender may need to determine to whom the original e-mail message was sent, who has replied to the original e-mail message, and who has not. In order to do this, the sender may need to review his or her original e-mail as well as all of the reply e-mails.

U.S. Patent Application Pub. No. US2005/0027779 A1 to Schinner discloses a system and method for organizing e-mail messages. Content from an original e-mail message is combined with responsive content from reply e-mail messages to form a consolidated e-mail message 500. However, the consolidated e-mail message is merely a combination of all of the body content of the original e-mail message and the reply e-mail messages, with some of the “from”, “sent”, “to”, and “subject” heading information eliminated.

U.S. Pat. No. 6,704,772 to Ahmed et. al. provides for organizing related electronic messages. An identifier may be assigned to an initial or original e-mail message and replies may be associated with the original message through the use of the identifier. The identifier allows for the automated creation of a message specific storage mechanism to hold the initial message and subsequent replies.

The prior art does not summarize the content of e-mail reply messages or present content of e-mail reply messages in a manner which allows a sender to quickly understand how a plurality of recipients have responded to an original e-mail message.

### BRIEF SUMMARY OF THE INVENTION

One or more embodiments of the present invention provide a method comprising sending a first original e-mail message to a plurality of recipients, and receiving a plurality of received e-mails. For each of the plurality of received e-mails, a computer, such as a sender's e-mail client computer or a sender's e-mail server computer, may determine if each received e-mail is a reply to the first original e-mail message. Data may be extracted from each received e-mail that is a reply to the first original e-mail message, wherein each received e-mail includes “from”, “sent”, “to”, and “subject” heading information, and body content information, and wherein the step of extracting eliminates some of the body content information. The method may further include aggregating the extracted data to form aggregated data, and displaying information relating to the aggregated data.

Information related to the aggregated data may be displayed on a computer monitor of the sender's e-mail client computer or the sender's e-mail server computer along with the first original e-mail message. The information may be a summary of the aggregated data. The method may further include inserting the information into an aggregate e-mail message, and sending the aggregate e-mail message out onto the internet.

In one embodiment of the present invention, the aggregated data may include at least one number which indicates how many recipients have responded to the first original e-mail message. The number may be a percentage, which indicates the percentage of recipients who have responded. The aggregated data may also include at least one number which indicates how many recipients have provided a specific type of response, such as a percentage of recipients who have provided a specific type of response. The aggregated data may include information specifying which recipients have not responded at all to the first original e-mail message.

In another embodiment of the present invention followup flags or fields may be provided in original e-mail messages. In response to selection of a first followup flag in a first original e-mail message, information related to a first original e-mail message may be saved in a to do list located in computer memory and/or displayed on a computer monitor of, for example, the sender's e-mail client computer. Information related to reply e-mail messages to the first original e-mail message may also be saved and/or displayed in the to do list in response to selection of the first followup flag.

Similarly, in response to selection of a second followup flag in a second original e-mail message, information related to a second original e-mail message may be saved in and/or displayed on the do list, and information related to reply e-mail messages to the second original e-mail message may also be saved in and/or displayed on the to do list.

### BRIEF DESCRIPTION OF THE DRAWINGS

FIG. 1 shows an apparatus for use in accordance with an embodiment of the present invention;

FIG. 2 shows a flow chart of a method of using the apparatus of FIG. 1;

FIG. 3 shows a first original e-mail message;

FIG. 4 shows a first reply e-mail message;

FIG. 5 shows a second reply e-mail message;

FIG. 6 shows an aggregated e-mail message;

FIG. 7 shows a to do list of tracked original e-mail messages; and

FIG. 8 shows a block diagram of a computer.

### DETAILED DESCRIPTION

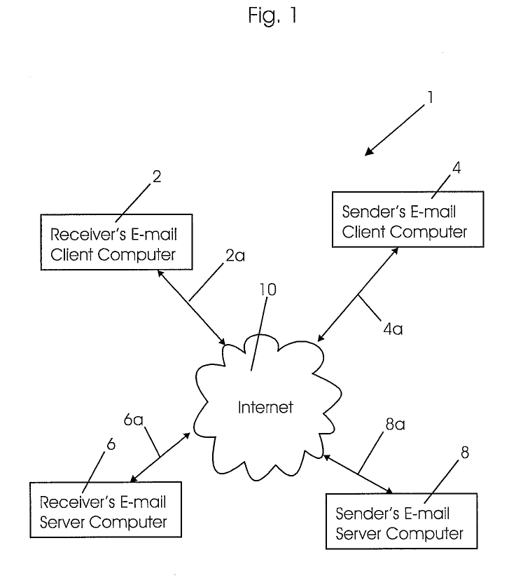

FIG. 1 shows an apparatus for use in accordance with an embodiment of the present invention. The apparatus 1 includes a receiver's e-mail client computer 2, a sender's e-mail client computer 4, a receiver's e-mail server computer 6, and a sender's e-mail server computer 8. The computers 2, 4, 6, and 8 communicate with the internet 10 via communications links 2a, 4a, 6a, and 8a, respectively, each of which may be any type of communication link.

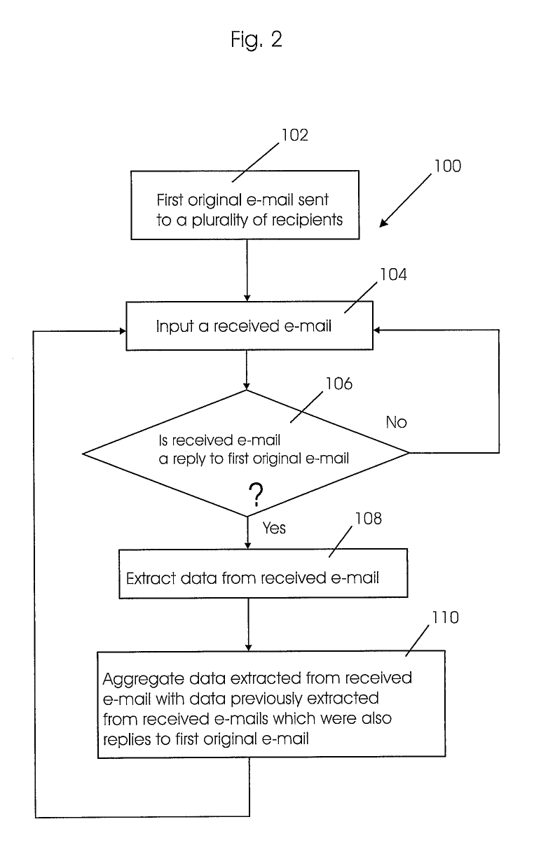

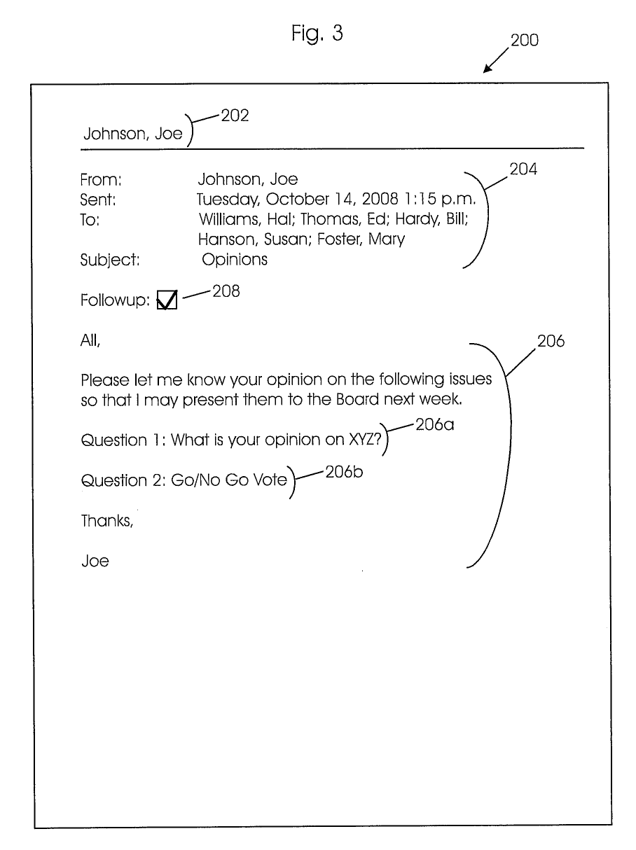

FIG. 2 shows a flow chart 100 of a method of using the apparatus 1 of FIG. 1, in accordance with an embodiment of the present invention. At step 102 a first original e-mail message 200 shown in FIG. 3, may be sent to a plurality of recipients from, for example, the sender's e-mail client computer 4 out onto the internet 10 shown in FIG. 1. The first original e-mail message 200 may be sent to the receiver's e-mail client computer 2 and to a plurality of further receiver e-mail client computers which may be connected to the internet 10 also, and which are not shown. The sender's e-mail client computer 4 may receive or input a received e-mail at step 104.

In a first iteration, the sender's e-mail client computer 4 receives a first received e-mail message at step 104. The sender's e-mail client computer 4 examines the first received e-mail message and determines if it is a reply to the first original e-mail message 200, at step 106. If the first received e-mail message is a reply then data is extracted from the first received e-mail message at step 108, if not then the next received e-mail message is examined, by looping back to step 104. In at least one embodiment, the step of data extraction, eliminates at least part of body content of a received e-mail.

Following step 108, the sender's e-mail client computer 4 aggregates data extracted from the most recent received e-mail with data previously extracted from received e-mails which were also replies to the first original e-mail message at step 110. In at least one embodiment of the present invention, the step of data extraction eliminates at least part of body content of a received e-mail. After aggregation, the method returns to step 104 to receive the next e-mail message.

The method 100 may be implemented by computer software running on the sender's e-mail client computer 4 and/or on the sender's e-mail server computer 8 shown in FIG. 1.

FIG. 3 shows the first original e-mail message 200. The first original e-mail message 200 may be displayed on a computer monitor of the sender's e-mail client computer 4 and/or stored in computer memory of the sender's e-mail client computer 4. The first original e-mail message 200 includes designation 202, transmission or heading content 204 (“from”, “sent”, “to”, “subject” heading information) and body content 206. The designation 202 may be the name of the sender of the first original e-mail message 200 which in this case is “Joe Johnson”. The transmission or heading content 204 may indicate who the first original e-mail message is from, when the original e-mail message was sent, to whom the first original e-mail message was sent, and the subject of the first original e-mail message. In the example of FIG. 3, the first original e-mail message 200 is being sent from Joe Johnson to five recipients which include Hal Williams, Ed Thomas, Bill Hardy, Susan Hanson, and Mary Foster. The subject concerns opinions.

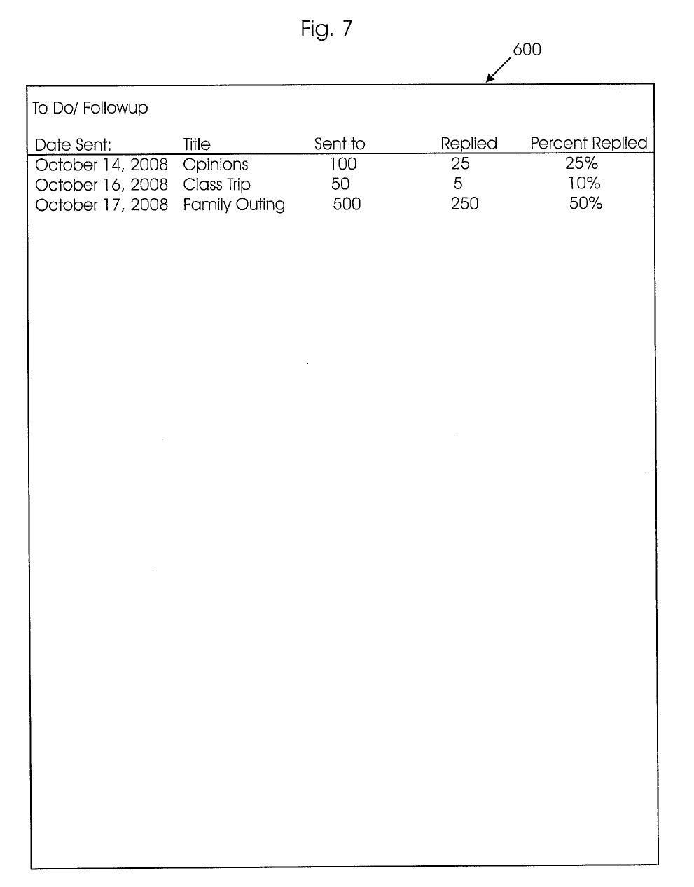

The first original e-mail message 200 also includes a followup field or flag 208. The follow field includes the designation of “Followup:” and a box in which is shown a check mark in FIG. 3. The check mark indicates that the first original e-mail message 200 and replies to the first original e-mail message 200 will be tracked in a followup or to do list 600 shown in FIG. 7. The to do list 600 may list a plurality of original e-mail messages which have been designated for tracking. The to do list 600 may be displayed on a computer monitor of the sender's e-mail client computer 4 and/or stored in computer memory of the sender's e-mail client computer 4. The to do list 600 may be in the form of a table, and may include a list of a plurality of original e-mails which may be displayed on a screen of a computer monitor or stored in computer memory of the sender's e-mail client computer 4. The do list 600 may include a column indicating a date when each e-mail message was sent, a column indicating a title or subject matter of the particular e-mail, a column indicating the number of recipients that the e-mail was sent to, a column indicating the number of recipients that replied to the e-mail, and a column indicating the percent of recipients that replied to the e-mail.

The original e-mail message sent on Oct. 14, 2008, concerning the Title “Opinions”, was sent to one hundred recipients, and a reply was received from twenty-five of those recipients for a percent replied of 25%. The original e-mail message sent on Oct. 16, 2008, concerning the Title “Class Trip”, was sent to fifty recipients, and a reply was received from five of those recipients for a percent replied of 10%. The original e-mail message sent on Oct. 17, 2008, concerning the Title “Opinions”, was sent to five hundred recipients, and a reply was received from two hundred fifty of those recipients for a percent replied of 50%.

In FIG. 7, three original e-mail messages are being tracked: the first original e-mail message 200 sent on Oct. 14, 2008 regarding the subject “Opinions” which was shown in FIG. 3, a second original e-mail message sent on Oct. 16, 2008 referring to the subject “Class Trip”, and a third original e-mail message sent on Oct. 17, 2008, referring to the subject “Family Outing”. The content of the second and third original e-mail messages is not shown, but the second and third e-mail messages may have different content and different recipients from each other and from the first original e-mail message 200 shown in FIG. 3. The first, second, and third original e-mail messages referred to in FIG. 7, may each be sent from Joe Johnson and from the sender's e-mail client computer 4 shown in FIG. 1. The first, second, and third original e-mail messages may each have a followup field or flag and box, similar to 208 in FIG. 3, which can be check marked to cause the corresponding original e-mail message to be tracked by the to do list 600. In one embodiment of the present invention, if the followup box, for the particular original e-mail message is not checked, then that original e-mail message will not be tracked by the to do list 600. Regardless of whether the appropriate followup box is checked, all of the original e-mail messages will be transferred to the Outbox as is typically done in the prior art for sent e-mail messages.

In the body content 206 of the first original e-mail message 200, two questions: “Question 1” and “Question 2” are presented to the recipients for their input. The body content 206 includes content 206a referring to the first question or issue and content 206b referring to the second content or issue.

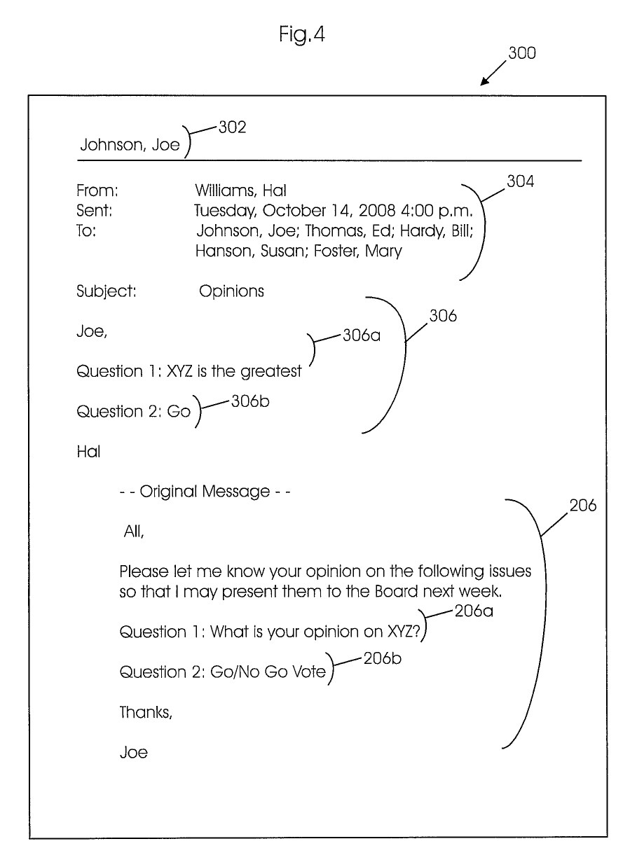

FIG. 4 shows a first reply e-mail message 300. The first reply e-mail message 300 may be displayed on a computer monitor and/or stored in computer memory of the sender's e-mail client computer 4. The first reply e-mail message 300 includes content 206 which is the same as or may be substantially the same as the body content 206 of the original e-mail message 200. The first reply e-mail message 300 includes a designation 302 which may be the same as the designation 202 for the original e-mail message 200. The first reply e-mail message 300 includes transmission or heading content 304 and reply body content 306. The transmission or heading content 304, similar to transmission or heading content 204 of the first original e-mail message 200, may indicate who the first reply e-mail message 300 is from, when the first reply e-mail message 300 was sent, to whom the first reply e-mail message 300 was sent, and the subject of the first reply e-mail message 300. In the example of FIG. 4, the first reply e-mail message 300 is being sent from Hal Williams to five recipients which include Joe Johnson, Ed Thomas, Bill Hardy, Susan Hanson, and Mary Foster. The subject concerns opinions.

In the reply body content 306, answers to the two questions, “Question 1” and “Question 2” are presented to the recipients, including as a reply to Joe Johnson's first original e-mail message 200. The body content 306 includes content 306a referring to the first question or issue and content 306b referring to the second content or issue.

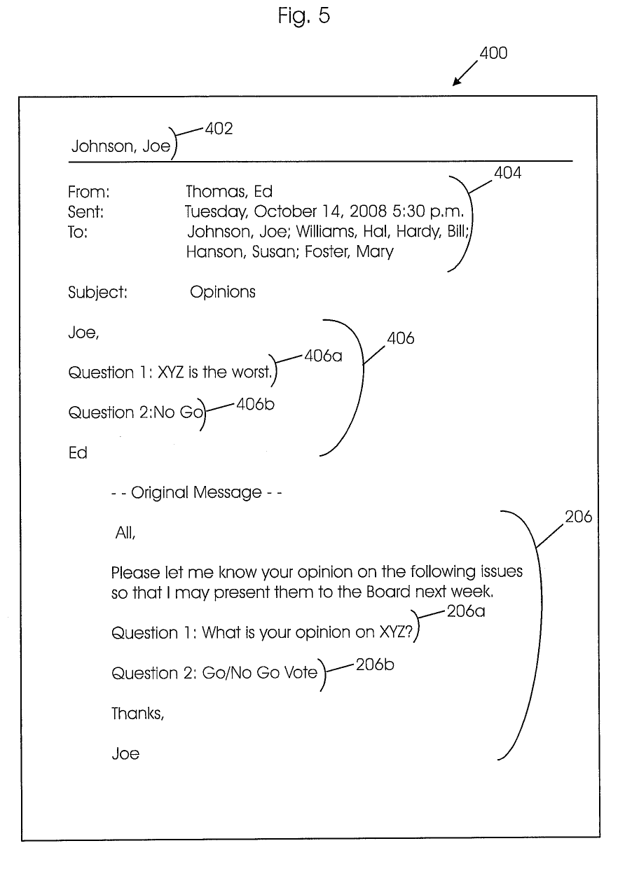

FIG. 5 shows a second reply e-mail message 400. The second reply e-mail message 400 may be displayed on a computer monitor and/or stored in computer memory of the sender's e-mail client computer 4. The second reply e-mail message 400 includes content 206 which is the same as or may be substantially the same as the body content 206 of the first original e-mail message 200. The second reply e-mail message 400 includes a designation 402 which may be the same as the designation 202 for the first original e-mail message 200 of FIG. 3. The second reply e-mail message 400 includes transmission content 404 and reply body content 406. The transmission content 404, similar to content 204 of the original e-mail message 200, may indicate who the reply e-mail message 400 is from, when the reply e-mail message 400 was sent, to whom the reply e-mail message 400 was sent, and the subject of the reply e-mail message 400. In the example of FIG. 5, the reply e-mail message 400 is being sent from Ed Thomas to five recipients, which include Joe Johnson, Hal Williams, Bill Hardy, Susan Hanson, and Mary Foster. The subject concerns opinions.

In the reply body content 406, answers to the two questions, “Question 1” and “Question 2” are presented to the recipients, including as a reply to Joe Johnson's first original e-mail message 200. The reply body content 406 includes content 406a referring to the first question or issue and content 406b referring to the second content or issue.

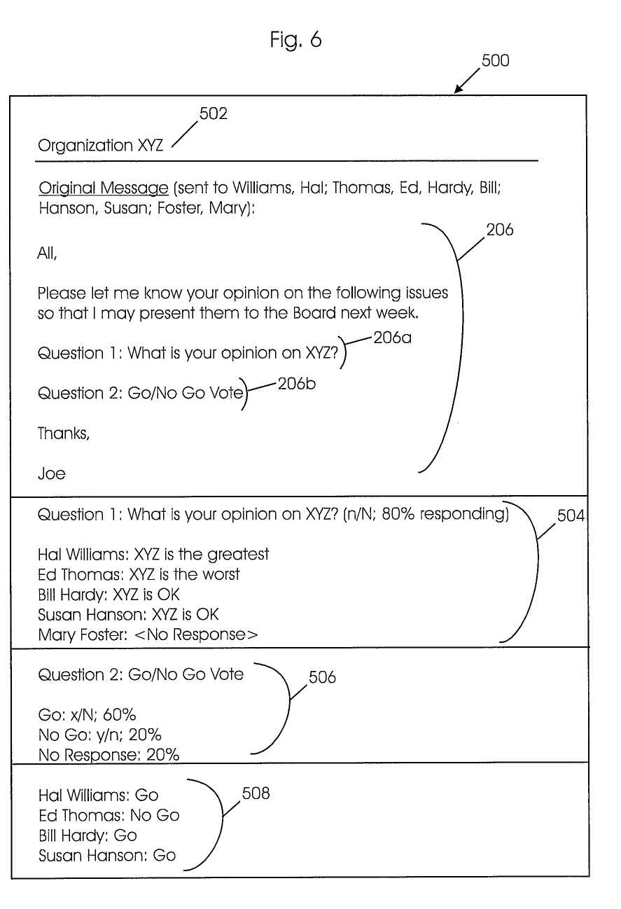

FIG. 6 shows an aggregated e-mail message 500. The aggregated e-mail message 500 may be displayed on a computer monitor and/or stored in a computer memory of the sender's e-mail client computer 4. The aggregated e-mail message 500 includes content 206, which is the same as or may be substantially the same as the body content 206 of the original e-mail message 200. The aggregated e-mail message 500 includes a designation 502 which may indicate the subject of the aggregated e-mail message 500 or of the original e-mail message 200. The designation 502 may be extracted from the original e-mail message 200 by the sender's e-mail client computer 4 and then placed as a heading in the aggregated e-mail message 500 to indicate the subject of the aggregated e-mail message 500.

The aggregated e-mail message 500 includes aggregated content 504, 506, and 508. The aggregated content 504 shows the question or issue referred to, indicates how many recipients have responded out of the total number of recipients, and indicates a percentage of recipients who have responded. In this example “n” refers to the number of recipients who have responded and “N” refers to the total number of recipients to whom the original e-mail message 200 was sent. The variables “n” and “N”, in this example, may be replaced by “4” and “5”, respectively, indicating that four recipients have responded out of five recipients to whom the first original e-mail message 200 was sent. The aggregated content 504 also lists the names of the recipients, an abbreviated version of their responses, if any, and if a recipient has not responded, a “<No Response>” indication is shown next to that recipient's name. In the example of FIG. 6, “Mary Foster” has not responded and a “<No Response>” is indicated next to her name. The responses, if any from each individual have been made more concise, with some of the unnecessary content from the body portion of the reply e-mail messages eliminated. For example, for the reply e-mail message 400, the content “Joe”, “Ed”, “Question 1”, and “Question 2” from the body content 406, has been eliminated and/or modified in providing the content “Ed Thomas: XYZ is the greatest” as shown in content 504 of aggregated e-mail message 500.

The aggregated content 506 shows the question or issue referred to, indicates the percentage of the total recipients that have responded favorably with a “Go” vote (60%), the percentage of the total recipients that have responded unfavorably with a “No Go” vote (20%), and the percentage of the total recipients that have responded with a “No Response” (20%).

The aggregated content 508 lists the names of the recipients who voted “Go” or “No Go” and their votes. The content 508 has eliminated and/or modified body content from the appropriate reply e-mail messages.

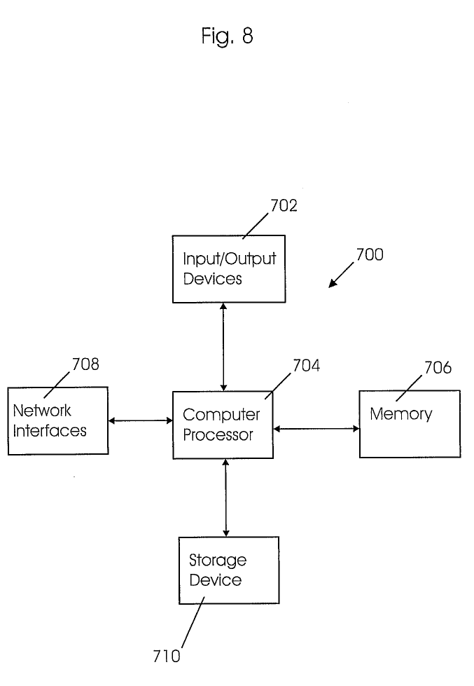

A high-level block diagram of a computer is illustrated in FIG. 8. Computer 700 contains a processor 704 which controls the overall operation of the computer 700 by executing computer program instructions which define such operation. The computer program instructions may be stored in a storage device 710 or other computer readable medium (e.g., magnetic disk, CD ROM, etc.), and loaded into a memory 706 when execution of the computer program instructions is desired. Thus, the method steps of FIG. 2 can be defined by the computer program instructions stored in the memory 706 and/or storage device 710 and controlled by the processor 704 executing the computer program instructions. For example, the computer program instructions can be implemented as computer executable code programmed by one skilled in the art to perform an algorithm defined by the method steps of FIG. 2. Accordingly, by executing the computer program instructions, the processor 704 executes an algorithm defined by the method steps of FIG. 2. The computer 700 also includes one or more network interfaces 708 for communicating with other devices via a network. The computer 700 also includes input/output devices 702 that enable user interaction with the computer 700 (e.g., display, keyboard, mouse, speakers, buttons, etc.) One skilled in the art will recognize that an implementation of an actual computer could contain other components as well, and that FIG. 8 is a high level representation of some of the components of such a computer for illustrative purposes.

Each of the receiver's e-mail client computer 2, the sender's e-mail client computer 4, the receiver's e-mail server computer 6, and the sender's e-mail server computer 8 may be a computer having an architecture similar or identical to the architecture of computer 700 of FIG. 8.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. A method comprising
sending a first original e-mail message to a plurality of recipients;
receiving a plurality of received e-mails;
for each of the plurality of received e-mails, determining if each received e-mail is a reply to the first original e-mail message;
extracting data from each received e-mail that is a reply to the first original e-mail message, wherein each received e-mail includes transmission content and body content, and wherein the step of extracting eliminates some of the body content information;
aggregating the extracted data to form aggregated data; and
displaying information relating to the aggregated data.

2. The method of claim 1 further comprising
displaying the information on a computer monitor along with the first original e-mail message.

3. The method of claim 1 wherein the information is a summary of the aggregated data.

4. The method of claim 1 further comprising
inserting the information into an aggregate e-mail message; and
sending the aggregate e-mail message via a data network to a specific recipient.

5. The method of claim 4 wherein
wherein the first original e-mail message is sent from an original e-mail address; and
wherein the aggregate e-mail message is sent to the original e-mail address.

6. The method of claim 1 wherein
the step of aggregating is performed by an e-mail server.

7. The method of claim 1 wherein
the step of aggregating is performed by an e-mail client computer.

8. The method of claim 1 further comprising
displaying the information within the original e-mail message.

9. The method of claim 1 wherein
the aggregated data includes at least one number which indicates how many recipients have responded.

10. The method of claim 9 wherein
the number indicates the percentage of recipients who have responded.

11. The method of claim 1 wherein
the aggregated data includes at least one number which indicates how many recipients have provided a specific type of response.

12. The method of claim 11 wherein
the number indicates the percentage of recipients who have provided a specific type of response.

13. The method of claim 1 wherein
the aggregated data includes information specifying which recipients have not responded to the original e-mail message.

14. The method of claim 1 further comprising
in response to selection of a first followup flag, saving information related to the first original e-mail message in a to do list located in computer memory, and saving information related to reply e-mail messages to the first original e-mail message in the to do list; and
in response to selection of a second followup flag, saving information related to a second original e-mail message into the do list, and saving information related to reply e-mail messages to the second original e-mail message in the to do list.

15. An apparatus comprising
means for sending a first original e-mail message to a plurality of recipients;
means for receiving a plurality of received e-mails;
means for determining if each received e-mail is a reply to the first original e-mail message;
means for extracting data from each received e-mail that is a reply to the first original e-mail message, wherein each received e-mail includes transmission content and body content, and wherein the means for extracting eliminates some of the body content information;
means for aggregating the extracted data to form aggregated data; and
means for displaying information relating to the aggregated data.

16. The apparatus of claim 15 wherein
the means for displaying information relating to the aggregated data comprises means for displaying the aggregated data along with the first original e-mail message.

17. The apparatus of claim 15 wherein
the information is a summary of the aggregated data.

18. The apparatus of claim 15 further comprising
means for inserting the information into an aggregate e-mail message; and
means for sending the aggregate e-mail message out onto the internet via a data network to a specific recipient.

19. The apparatus of claim 18 wherein
the means for sending the first original e-mail message comprises means for sending the first original e-mail message from an original e-mail address; and
the means for sending the aggregate e-mail message comprises means for sending the aggregate e-mail message to the original e-mail address.

20. The apparatus of claim 15 wherein
the means for aggregating includes an e-mail server.

21. The apparatus of claim 15 wherein
the means for aggregating includes an e-mail client computer.

22. The apparatus of claim 15 wherein
the means for displaying information related to the aggregated data comprises means for displaying the aggregated data within the original e-mail message.

23. The apparatus of claim 15 wherein
the aggregated data includes at least one number which indicates how many recipients have responded.

24. The apparatus of claim 23 wherein
the number indicates the percentage of recipients who have responded.

25. The apparatus of claim 15 wherein
the aggregated data includes at least one number which indicates how many recipients have provided a specific type of response.

26. The apparatus of claim 25 wherein
the number indicates the percentage of recipients who have provided a specific type of response.

27. The apparatus of claim 15 wherein
the aggregated data includes information specifying which recipients have not responded to the original e-mail message.

28. The apparatus of claim 15 further comprising
means for saving information related to the first original e-mail message in a to do list and saving information related to reply e-mail messages to the first original e-mail message in the to do list in response to selection of a first followup flag; and
means for saving information related to a second original e-mail message in the to do list, and saving information related to reply e-mail messages to the second original e-mail message in the to do list in response to selection of a second followup flag.

29. A computer readable medium comprising computer executable instructions which, when executed by a processor, perform the steps of:
sending a first original e-mail message to a plurality of recipients;
receiving a plurality of received e-mails;
for each of the plurality of received e-mails, determining if each received e-mail is a reply to the first original e-mail message;
extracting data from each received e-mail that is a reply to the first original e-mail message, wherein each received e-mail includes transmission content and body content, and wherein the step of extracting eliminates some of the body content information;
aggregating the extracted data to form aggregated data; and
displaying information relating to the aggregated data.

30. The computer readable medium of claim 29 wherein
the information is a summary of the aggregated data.

31. The computer readable medium of claim 29 wherein the computer executable instructions, when executed by the processor, perform the further steps of:
inserting the information into an aggregate e-mail message; and
sending the aggregate e-mail message via a data network to a specific recipient.

32. The computer readable medium of claim 29 wherein
the aggregated data includes at least one number which indicates how many recipients have responded.

33. The computer readable medium of claim 29 wherein
the aggregated data includes at least one number which indicates how many recipients have provided a specific type of response.

34. The computer readable medium of claim 29 wherein
the aggregated data includes information specifying which recipients have not responded to the original e-mail message.

35. The computer readable medium of claim 29 wherein the computer executable instructions, when executed by the processor, perform the further steps of:
in response to selection of a first followup flag, saving information related to the first original e-mail message in a to do list located in computer memory, and saving information related to reply e-mail messages to the first original e-mail message in the to do list; and
in response to selection of a second followup flag, saving information related to a second original e-mail message into the do list, and saving information related to reply e-mail messages to the second original e-mail message in the to do list.
